(19) United States
(12) Patent Application Publication
(10) Pub. No.: US 2017/0153702 A1
(43) Pub. Date: Jun. 1, 2017

(54) PROVIDING HAPTIC FEEDBACK USING CONTEXT ANALYSIS AND ANALYTICS

(71) Applicant: International Business Machines Corporation, Armonk, NY (US)

(72) Inventors: Faried Abrahams, Laytonsville, MD (US); Michael E. Alexander, Great Falls, VA (US); Jigneshkumar K. Karia, Thane (IN); Gandhi Sivakumar, Victoria (AU); Rambabu Yerra, Visakhapatnam (IN)

(21) Appl. No.: 14/953,107

(22) Filed: Nov. 27, 2015

(51) Int. Cl. G06F 3/01; G06F 17/30

(52) U.S. Cl. CPC G06F 3/016; G06F 3/015; G06F 17/30867; G06F 17/30964; G06F 17/30241

(57) ABSTRACT

Providing and/or determining haptic feedback may include, responsive to determining that a user is proximate to a haptic feedback device, determining, using a processor, a location of the haptic feedback device, and receiving, using the processor, a plurality of external factors determined from the location of the haptic feedback device, biometric data for the user, and social networking data for the user. The method may also include determining, using the processor, a haptic feedback for use by the haptic feedback device by applying the external factors to a haptic feedback template of an object.

### BACKGROUND

The inventive arrangements described within this disclosure relate to providing haptic feedback.

Users accessing content through a computer or other communication device have long been able to see and/or hear audiovisual material. Users routinely view images of objects while shopping through Websites and/or performing any of a variety of other activities online. In many cases, an image of a physical object viewed through a browser conveys enough information for a user to make a decision about the object. In other cases, images do not provide the user with sufficient information about the object.

As an example, a user may be looking to purchase a garment. Images of garments as viewed through a Website convey information such as style, color, cut, and the like of the garments. The user is also able read descriptions of the garments and possibly the materials used to make the garments.

Haptics technology has been used to provide users with the feel of an object. Available haptics systems tend to utilize static models of objects. This means that the haptic feedback provided for a particular object is constant, or unchanging, regardless of the circumstances in which that haptic feedback is provided and/or regardless of the particular user to whom the haptic feedback is directed.

### SUMMARY

An embodiment of the present invention may include a method. The method may include, responsive to determining that a user is proximate to a haptic feedback device, determining, using a processor, a location of the haptic feedback device. The method may include receiving, using the processor, a plurality of external factors determined from the location of the haptic feedback device, biometric data for the user, and social networking data for the user. The method may also include determining, using the processor, a haptic feedback for use by the haptic feedback device by applying the external factors to a haptic feedback template of an object.

Another embodiment may include a system. The system may include a processor programmed to initiate executable operations as described within this disclosure. The executable operations may include, responsive to determining that a user is proximate to a haptic feedback device, determining a location of the haptic feedback device. The executable operations may include receiving a plurality of external factors determined from the location of the haptic feedback device, biometric data for the user, and social networking data for the user. The method may also include determining a haptic feedback for use by the haptic feedback device by applying the external factors to a haptic feedback template of an object.

Still another embodiment may include a computer program product. The computer program product may include a computer readable storage medium having program code stored thereon. The program code is executable by a processor to perform a method. The method may include, responsive to determining that a user is proximate to a haptic feedback device, determining, using a processor, a location of the haptic feedback device. The method may include receiving, using the processor, a plurality of external factors determined from the location of the haptic feedback device, biometric data for the user, and social networking data for the user. The method may also include determining, using the processor, a haptic feedback for use by the haptic feedback device by applying the external factors to a haptic feedback template of an object.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 is a block diagram illustrating an exemplary network computing system.

FIG. 2 is a block diagram illustrating an exemplary implementation of a haptic feedback system.

FIG. 3 is a flow chart illustrating an exemplary method of providing haptic feedback.

FIG. 4 is a block diagram illustrating an exemplary architecture for a data processing system.

FIG. 5 is a block diagram illustrating an exemplary architecture for a haptic feedback device.

### DETAILED DESCRIPTION

The inventive arrangements described within this disclosure relate to providing haptic feedback. In accordance with the inventive arrangements described herein, haptic feedback may be provided to a haptic feedback device of a user. Each of a plurality of physical objects may be associated with a particular haptic feedback template. The haptic feedback templates may specify various haptic feedback properties of the object being modeled. Haptic feedback for an object may be determined from the haptic feedback template associated with the object and provided to a haptic feedback device of a user.

In one arrangement, the haptic feedback for a given object may be adjusted in accordance with one or more external factors as applied to the haptic feedback template for the object. For example, haptic feedback templates may specify sensitivity of haptic feedback properties to one or more external factors, dependencies among haptic feedback properties of an object, and the like. The external factors may be extracted from a plurality of different data sources. The data sources may provide data statically, in real time, and/or in near real time. The data sources may include, or specify, information about the environment in which the haptic feedback device is located, information specific to the user of the haptic feedback device, the type of the haptic feedback device being used, and the like.

Haptic feedback may be determined from the haptic feedback template(s) and provided to a haptic feedback device of a user. By using the haptic feedback templates and the external factors, the inventive arrangements described within this disclosure provide users with a personalized tactile experience. The ability to adjust the haptic feedback provided to the user based upon the external factors described herein allows haptic feedback to be tailored to a user, the context of the user, and/or the haptic feedback device of the user.

For example, the haptic feedback for an object may vary with external factors relating to location of the haptic feedback device, biometric data of the user, social networking data for the user, and the like. This means that a same object may have different emulated feels for a same user when experienced in different locations, have different emulated feels for different users, etc. Further, the manner in which the feel of one object varies with the external parameters may be different from the manner in which the feel of a second object varies with the external parameters as defined in each respective haptic feedback template. Use of haptic feedback templates provides increased flexibility in emulating the feel of an object in a variety of different contexts.

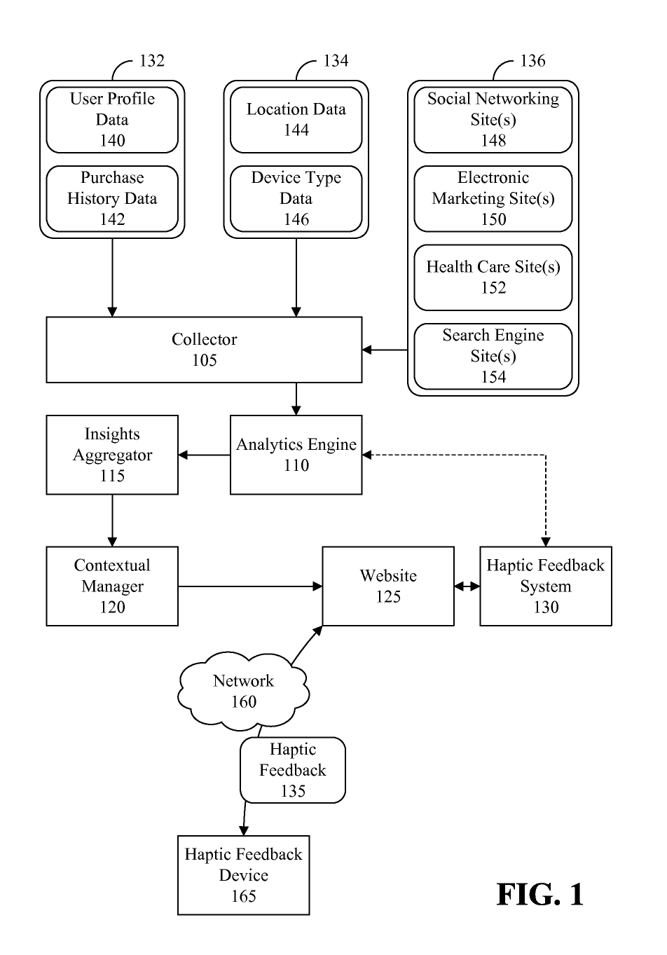

FIG. 1 is a block diagram illustrating an exemplary network computing system (system) 100. System 100 may include one or more networked data processing systems. As pictured, system 100 may include a collector 105, an analytics engine 110, an insights aggregator 115, a contextual manager 120, a Website 125, and a haptic feedback system 130. In one aspect, each of collector 105, analytics engine 110, insights aggregator 115, contextual manager 120, Website 125, and haptic feedback system 130 may be implemented as one or more data processing systems, e.g., servers. In another aspect, one or more of the aforementioned components may be combined and implemented in a same data processing system. For example, Website 125, which may be a commerce Website, may include haptic feedback system 130. FIG. 1 is provided for purposes of illustration only and is not intended to limit the inventive arrangements described within this disclosure.

Collector 105 may be configured to obtain and/or aggregate data from a plurality of different data sources. For purposes of illustration, the data sources illustrated in FIG. 1 have been placed into different groupings. It should be appreciated that the data sources illustrated and the groupings of the data sources are not intended as limitations of the inventive arrangements described herein. Data sources have been grouped for ease of illustration and description. Further, the term “data source,” as used herein, may refer to a data processing system, a data storage device, a network accessible data storage device, a Web-based service and/or site, or the like.

As pictured, collector 105 may obtain data from near real time data sources 132, real time data sources 134, and/or unstructured data sources 136. Near real time data sources 132 may include user (e.g., customer) profile data 140 and/or purchase history data 142. A user may register with the system and create a user profile through a registration process. A user profile may include or specify data items for the user including, but not limited to, the name of the user, gender, age and/or date of birth, income, occupation, education, and/or any physical disabilities the user may have such as any visual impairments. A user profile may also specify preferences for the user such as color for various items, sizes of various items of clothing, language fluency, and the like.

Purchase history data 142 may specify a preferred channel of commerce on a per user basis such as Web-based e-commerce, mobile e-commerce, retailer, etc. Purchase history data 142 may also specify spending areas such as apparel, electronics, etc., spending value for a particular duration such as a month, year, or the like, payment method such as credit card, cash, and/or purchase location on a per user basis. Purchase history data 142 further may specify a most recent country and/or location visited by the user. In still another example, purchase history data 142 may include an actual history of items purchased using a mobile device or other device as may be obtained from an electronic wallet application, electronic payment system, Web-based payment system, or the like.

Real time data sources 134 may include location data 144 and device type data 146. Location data 144 may be collected and obtained from a user device, e.g., using GPS, purchase transactions, or the like. In one arrangement, location data 144 may be obtained from a device of the user. The device may a haptic feedback device or may not be a haptic feedback device. Device type data 146 may specify the particular type of device a user is currently using. As noted, the device may or may not be a haptic feedback device. In cases where the device of a user is a haptic feedback device, device type data 146 may specify information such as the particular haptic feedback device being used, e.g., whether a mobile haptic feedback device or a wearable haptic feedback device, the particular haptic feedback unit or units included in the device, e.g., a haptic display screen, a haptic feedback glove, a haptic feedback bracelet, or the like.

Unstructured data sources 136 may include data obtained from social networking sites 148, electronic marketing sites 150, health care sites 152, and search engine site(s) 154 for a particular user. As defined herein, the term “social networking site” or “social networking service” is a computing platform that allows users to build social networks or social relations among people who share similar interests, activities, backgrounds or real-life connections. Social networking data is data received from a social networking site and/or service. As an example, collector 105 may receive one or more feeds from social networking sites 148. The feeds may include a language score, a friend's language score, profile information for friends of the user, the location of friends of the user, sentiment feeds indicating emotional state of a user such as happy or sad, and the like.

Collector 105 may receive electronic marketing feeds from electronic marketing sites 150 for a user. Electronic commerce data is data received from electronic marketing sites. Electronic marketing feeds may include electronic commerce website marketing scores, shared favorite products, spending areas, review comments, brand scores, and the like.

Collector 105 may also receive one or more healthcare feeds from health care sites 152 for a user. As defined herein, the term “health care site” or “health care service” is a computing platform that stores and/or maintains biometric information for one or more users. The healthcare feeds may specify particular biometric data for the user. Biometric information is information describing a health related condition of a user. Biometric information may include medical information. A health care site may be provided by a medical services provider and/or another party. Examples of biometric data may include, but are not limited to, an allergy, a medical diagnosis or condition, an affliction, a trait such as a facial pattern, skin sensitivity, eye color, or the like. Biometric data may also include real time information for a user such as the user's body temperature, perspiration level and/or wetness and/or dryness in one's hand, blood pressure, or the like.

Collector 105 may also receive search engine feeds from search engine site(s) 154. Search engine feeds may specify recent searches initiated by a user, recent search items, search results selected by the user, and the like. The exemplary data sources described with reference to FIG. 1 are provided for purposes of illustration only. Collector 105 may receive data from one or more other data sources or receive data from fewer data sources than described.

Collector 105 may aggregate data from the various data sources noted. Data may be aggregated on a per-user basis. Collector 105 may provide the aggregated data to analytics engine 110. Analytics engine 110 may determine one or more external factors for a given user and/or haptic feedback device of the user. For example, analytics engine 110 may extract data items as described from the received data as “external factors.”

In another example, analytics engine 110 may use data items from the data sources to determine supplemental data from which additional external factors may be determined and/or extracted. For example, analytics engine 110 may determine a location of a haptic feedback device as an external factor and further determine environment data for the location of the haptic feedback device used by a user. The analytics engine may extract further external factors from the environment data such as temperature, climate, or the like. As defined herein, the term “environment data” means information describing the climate and/or geographical area where a haptic feedback device of a user is located. For example, environment data may include, but is not limited to, weather conditions for a location given a current date and/or time, altitude, and the like.

In another example, analytics engine 110 may determine emotional state, e.g., a mood, as an external factor from the social networking data. In some cases, emotional state may be explicitly specified within the social networking feed(s) and analytics engine 110 may determine the emotional state of a user directly from the social networking feed(s). In other cases, analytics engine 110 may determine emotional state through semantic analysis of posts, updates, comments, and/or the like of the user on one or more social networking sites.

Analytics engine 110 may also generate insights based upon the received data. Analytics engine 110 may provide insights and/or any extracted external parameters to insights aggregator 115. Insights aggregator 115 may aggregate the insights and, using the insights, generate dynamic segments of users, e.g., groups of users. Insights aggregator 115 may provide the dynamic segments of users to contextual manager 120. Contextual manager 120 may select one or more objects determined to be of interest for users in the various segments. For example, contextual manager 120 may select one or more objects, e.g., products, which may be presented to users during a Web-browsing session with Website 125 as promotional items determined to be related to the user.

Table 1 illustrates exemplary segments and the particular external factors, or factor areas, that analytics engine 110 and/or insights aggregator 115 may determine from the data sources. Contextual manager 120 may determine an exemplary recommendation for each of the segments as shown in Table 1 indicating a particular object or class of object to be presented, e.g., as a model, to the user through his or her device or haptic feedback device. Haptic feedback system 130 may provide haptic feedback for each of the objects recommended to the user device as a suggestion.

TABLE 1

| Example | Segment Definition | Recommendation |
|---|---|---|
| 1 | Male, age <30, winter, temperature | Soft wool sweet |
| | between 15-19 degrees, blind, size | sweater |
| | preference, color preference, soft | |
| | material preference, haptics supported | |
| | device used | |
| 2 | Male, age <30, winter, temperature | Hard wool sweet |
| | between 15-19 degrees, blind, size | sweater |
| | preference, no soft material preference, | |
| | haptics supported device | |
| 3 | Male, winter, temperature between 0-5 | Winter boots of |
| | degrees, blind, size preference, brand | shape, material |
| | preference, weight preference, haptics | type (surface), |
| | supported device | color, and |
| | | weight matching |
| | | preference |
| 4 | Friend birthday, place, season, weather, | Gift an apparel |
| | spending areas, personal income, spending | |
| | value, haptics supported device used | |
| 5 | Female, age >30, rash on hands, blind, | Full sleeves, |
| | haptics supported device | soft, cotton |
| 6 | Favorite item stored in other Website | Recently searched |
| | or recently searched product, haptics | product |
| | supported device | |
| 7 | Happy mood, frequently a visitor of | Favorite product |
| | Website, favorite product stored in | |
| | Website, haptics supported device used | |
| 8 | Happy mood, income, spending areas, | Precious and |
| | haptics supported device | high valued |
| | | and/or priced |
| | | products |
| 9 | Sad mood, income, spending areas, | Lower or |
| | haptics supported device used | discounted |
| | | price segment |
| | | products to |
| | | be shown |

In illustration, a user may initiate a Web-browsing session with Website 125 through network 160. Network 160 is the medium used to provide communications links between various devices and data processing systems connected together within system 100. Network 160 may include connections, such as wire, wireless communication links, or fiber optic cables. Network 160 may be implemented as, or include, any of a variety of different communication technologies such as a Wide Area Network (WAN), a Local Area Network (LAN), a wireless network (e.g., a wireless WAN and/or a wireless LAN), a mobile network, a Virtual Private Network (VPN), the Internet, the Public Switched Telephone Network (PSTN), or the like.

The user may conduct the Web-browsing session using haptic feedback device 165. A model for objects selected by the user during the Web-browsing session and/or a model for objects selected by contextual manager 120 may be sent to haptic feedback device 165 (or another device of the user that does not have a haptic feedback unit) for presentation or rendering on the device through network 160. As used herein, the term “model,” as applied to an object (e.g., an object model), means a representation of a physical object presented through a data processing system and/or a communication device. A model may be an image or other visual representation of an object that may be displayed on a computing device. For example, a model may be a selectable image displayed as part of a Webpage, an image displayed in a mobile Web-based application, a 2D view, a 3D view, or the like.

In one aspect, Website 125 may operate in cooperation with haptic feedback system 130. Haptic feedback system 130 may determine haptic feedback 135 for one or more models of objects provided to haptic feedback device 165. Haptic feedback, as defined within this disclosure, means a set of instructions and/or properties that may be executed, or rendered, by a haptic feedback device and, more particularly, by a haptic feedback sensor of a haptic feedback device to simulate a tactile feel of an object.

As illustrated in FIG. 1, haptic feedback 135 may be provided to haptic feedback device 165 for the user. In one arrangement, haptic feedback device 165 may be a device that is configured to facilitate Web-browsing and/or data access that includes a haptic feedback sensor for rendering haptic feedback. For example, haptic feedback device 165 may be a mobile phone having a display screen that is configured as, or includes, a haptic feedback sensor. Haptic feedback device 165 may be a portable computer such as a laptop and/or a tablet having a display screen that is configured as, or includes, a haptic feedback unit.

In other cases, the user may utilize a first device such as a communication and/or computing device that may not be configured to render haptic feedback. The user may utilize the first device to access content and/or view a model of an object. The user may have a second, different device that does render haptic feedback. Accordingly, haptic feedback 135 may be provided to the second device configured to render haptic feedback. In this example, for purposes of illustration, haptic feedback device 165 is the second device and may be a wearable device such as a haptic enabled glove, a haptic enabled wrist band, or the like. In some cases, haptic feedback device 165 may be coupled to the first device and/or communicatively linked to the first device so that haptic feedback 135 may be sent to the first device and on through to the second device.

In one arrangement, whether requested by the user via a device or automatically selected and provided to the device of the user, haptic feedback 135 may be sent with an associated object model. As discussed, in one example, a Webpage specifying the object model and the haptic feedback for the object model may be sent to haptic feedback device 165. Accordingly, responsive to the user touching or interacting with the model, e.g., an image of the object presented on a display screen, the haptic feedback sensor of the haptic feedback device may render haptic feedback 135 emulating feel of the object.

In one arrangement, haptic feedback system 130 may receive external factors via Website 125 as part of a request for haptic feedback for one or more objects. In another arrangement, haptic feedback system 130 may receive external factors from analytics engine 110 responsive to a request. For example, Website 125 may request haptic feedback for an object and for a particular user and/or haptic feedback device. Haptic feedback system 130 may query analytics engine 110 for external factors relating to the user and the haptic feedback device of the user. As noted, a variety of different data sources may be used to obtain and/or derive the external factors. These external factors may relate to the user himself/herself, the haptic feedback device used by the user such as location and/or other environment data that may be determined using location, and/or social networking data for the user.

Haptic feedback system 130 may select a haptic feedback template for the particular objects for which haptic feedback is requested. Haptic feedback system may adapt the haptic feedback template according to the external factors to generate haptic feedback 135.

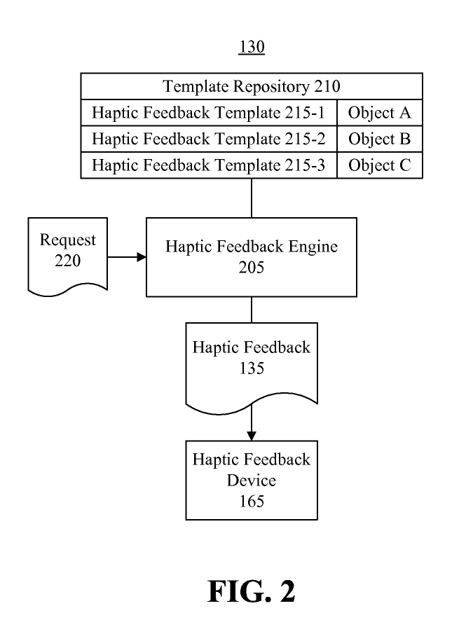

FIG. 2 is a block diagram illustrating an exemplary implementation of haptic feedback system 130 of FIG. 1. As pictured, haptic feedback system 130 may include a haptic feedback engine 205 and a template repository 210. In general, haptic feedback engine 205 may determine haptic feedback 135 for a particular object given a set of one or more external factors.

In one arrangement, haptic feedback engine 205 may receive a request 220. Request 220 may be a communication requesting haptic feedback for one or more objects. In one arrangement, request 220 may be from a server such as Website 125 of FIG. 1. Website 125, for example, may provide object models to a user device and provide haptic feedback to a haptic feedback device (which may be the user device) accompanying the object model(s). In one aspect, request 220 may specify the particular objects for which haptic feedback is needed and one or more external factors. It should be appreciated that the external factors may include or specify the location of the user, an identity of the user, other user specific information such as biometric information and social networking data, environment data surrounding the haptic feedback device of the user, and the like. The object model(s) and/or haptic feedback may also be provided to a user device, e.g., a haptic feedback device, responsive to a request originating from the user device.

In another arrangement, external factors may be obtained, at least in part, by haptic feedback engine 205 from an analytics system such as analytics engine 110. In still another arrangement, one or more or all of external factors may be obtained by haptic feedback engine 205 from one or more of the data sources discussed with reference to FIG. 1. For example, user profile data and/or other structured data may be provided directly to haptic feedback engine 205 since such data may explicitly specify external factors and require little or no processing for factor extraction.

In still another arrangement, in response to request 220 specifying an object, haptic feedback engine 205 may locate a haptic feedback template 215 for the specified object. As pictured, haptic feedback engine 205 may be coupled to template repository 210. Template repository 210 may store a plurality of haptic feedback templates (templates) 215. Template repository 210 may be a data storage device. Haptic feedback templates 215 may be specified as database entries, as markup language files, or another type of data structure or file. Each template 215 may be associated with a particular object. Further, each template 215 may provide an object-specific mapping of external factors to haptic feedback properties of the object.

For example, each template 215 may specify one or more haptic feedback properties for the object and whether each haptic feedback property is sensitive to an external factor. In cases where template 215 indicates that a haptic feedback property is sensitive to an external factor, template 215 may specify the external factors to which the haptic feedback property is sensitive, the manner of sensitivity, and/or the degree of sensitivity. For purposes of illustration, examples of external factors may include, but are not limited to, gravitation force, temperature, humidity, skin sensitivity of a user, emotional state of a user, and the like. For purposes of illustration, examples of haptic feedback properties may include, but are not limited to, tactile texture of the surface of an object, weight of the object, momentum of an object, rigidity of the object, elasticity of the object, and the like.

In illustration, haptic feedback template 215-1 for an object A may specify that the haptic feedback property of tactile texture for object A, as perceived by a user, is sensitive to the external factor of gravitational force. Gravitational force at one location may be different from the gravitational force at a second and different location. Haptic feedback template 215-1 for object A may specify this relationship as well as the extent to which tactile texture may vary from changing gravitational force for object A. As an illustrative example, haptic feedback template 215-1 may specify that tactile texture becomes increasingly rough with increased gravitational force and specify the degree of increased roughness relative to changes in gravitational force.

Templates 215 allow haptic feedback system 130 to adjust the haptic feedback provided for an object and tailor that haptic feedback based upon external factors that may be detected for, in, and/or around the user at or around the time that the haptic feedback is to be provided. Further, templates 215 allow haptic feedback system 130 to further tailor the haptic feedback provided in a manner that accounts for object-specific characteristics. Templates 215 may indicate, on an object-specific basis, which haptic feedback properties are and are not sensitive to external parameters. This permits the feel of each object to be tailored to the particular characteristics of the object itself. One haptic feedback property for a first object, for example, may vary with external factors, while the same haptic feedback property for a second, different object may be constant and, as such, not dependent upon external factors.

In another example, template 215-2 for object B may specify that texture of object B is perceived by users to vary responsive to temperature. Template 215-2, for example, may indicate that the texture of object B becomes increasingly rough with increased temperature. Template 215-3 for object C, by comparison, may specify that texture for object C is not perceived by users to vary responsive to temperature. Alternatively, template 215-3 may specify that texture for object C is perceived by users to become less rough with increased temperature.

Thus, templates 215 allow object-specific haptic feedback that may vary in an object-specific manner with the received external factors. In other words, the external factors may influence the same haptic feedback properties of different objects differently. Templates 215 allow a particular haptic feedback property to be variable for one object, remain constant for another object, vary in a first direction for yet another object, and vary in a second and/or opposing direction for still another object. Templates 215 allow the haptic feedback for objects to be varied not only based upon external factors, but also based upon physical characteristics of the objects themselves and how one perceives the feel of the objects to change given the determined external factors.

In still another arrangement, templates 215 may specify interactions of external factors and how one or more haptic feedback properties may vary responsive to the combination of multiple external factors. For example, template 215-3 may specify that the haptic feedback property of tactile texture is not variable to temperature (a second external factor) unless the user is determined to have sensitive skin (a first external factor). In the case where the user has sensitive skin, the haptic feedback property of tactile texture may be varied according to temperature. In the case where the user does not have sensitive skin, the haptic feedback property of tactile texture is not varied according to temperature. In another example, the amount by which a haptic feedback property varies may be dependent upon one or more other factors. For example, tactile texture may be varied more for a user with a higher level of skin sensitivity than for a user with a lower level of skin sensitivity.

Continuing with the example of FIG. 2, haptic feedback engine 205 may receive request 220 for haptic feedback for one or more particular objects. Further, request 220 may specify the particular user, e.g., as an external factor, to which the haptic feedback is to be sent or directed and/or other user-specific external factors as described herein, whether environment factors, biometric factors, or the like. Haptic feedback engine 205 may be configured to generate haptic feedback 135 for the particular object or object(s) specified by request 220 using templates 215 and any provided external factors.

As such, a range of haptic feedback may be defined for objects using templates 215 and varied according to the external factors. Some objects may be specified, using template 215, to be sensitive to particular external factors while other objects are not.

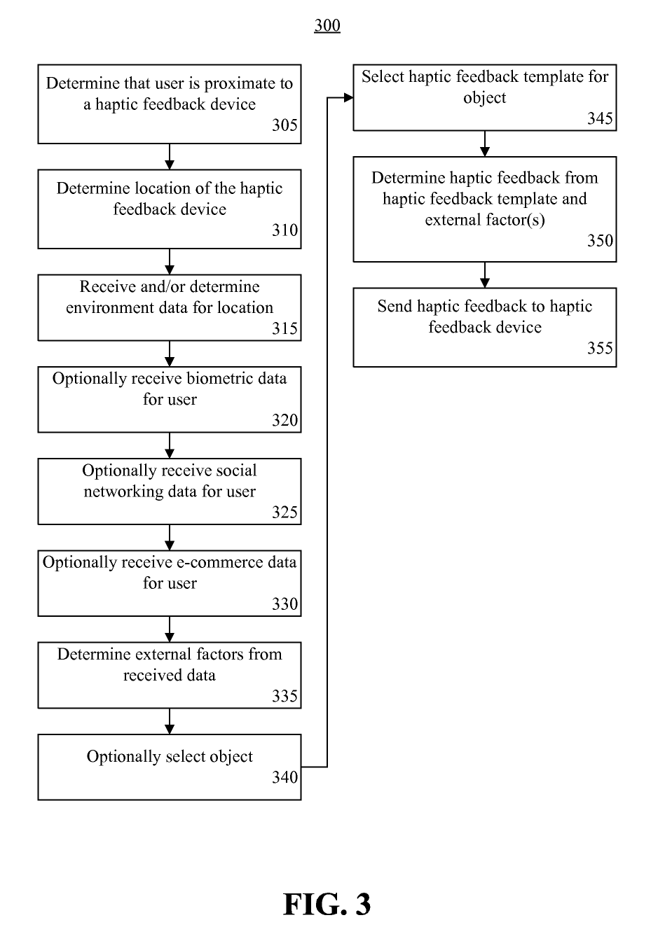

FIG. 3 is a flow chart illustrating an exemplary method 300 of providing haptic feedback. Method 300 may be performed using a haptic feedback system as described within this disclosure. In one arrangement, external factors may be determined as described with reference to FIG. 1. It should be appreciated, however, that the inventive arrangements described within this disclosure are not intended to be limited by the manner in which external factors are determined and/or provided to the haptic feedback system.

In block 305, the system may determine that a user is proximate to a haptic feedback device. For example, the system may determine that the user is using a haptic feedback device to access a Website or other data service and thereby determine proximity of the user to the haptic feedback device. In another example, the system may determine that the user is accessing a Website or other data service while using a haptic feedback device such as a wearable haptic feedback device that may be used in cooperation with, or coupled to, another device such as the device used to access the Website or data service.

In block 310, the system may determine the location of the haptic feedback device. The system may determine location using GPS coordinates received from the haptic feedback device, from social networking data, purchase history, a user profile, or the like. In one aspect, block 310 may be performed responsive to block 305.

In block 315, the system may receive and/or determine environment data for the location of the haptic feedback device. In block 320, the system may optionally receive biometric data for the user. In block 325, the system may optionally receive social networking data for the user. In block 330, the system may optionally receive e-commerce data for the user. In one aspect, data may be received from one or more of the data sources described herein as a real time data feed.

In block 335, the system may determine one or more external factors from the received data. In block 340, the system may select an object for presentation to the user. For example, the system may select an object and model object that may be delivered to a device of the user. In one arrangement, the system may select an object according to the dynamically generated segment to which the user belongs. As such, the system determines that haptic feedback is needed for the object.

In one aspect, the system may receive a request specifying an object from another system such as a Website and/or service, the haptic feedback device of the user, another device of the user, or the like. The request may also specify more than one object for which haptic feedback is needed. As noted, the request may also include the external factors.

In block 345, the system may select a template for the particular object determined in block 340. In block 350, the system may determine haptic feedback from the haptic feedback template and the external factors. As discussed, the template defines which haptic feedback properties of an object are sensitive to external factors. The system may modify and/or adjust one or more of the haptic feedback properties responsive to an external factor and/or a combination of external factors as defined in the template for the object.

For example, the system may determine which of the haptic feedback properties of the template are sensitive, e.g., variable, responsive to external factors. In response to determining which haptic feedback properties are sensitive and the particular external factors to which each is sensitive, the system may adjust the haptic feedback propert(ies) according to the external factors. In some cases, one or more haptic feedback properties may be determined to be variable according to a first external factor. Responsive to determining that the haptic feedback properties are variable from the first external factor, the system may adjust the haptic feedback properties according to a second or more different external factors or according to the first external factor and a second external factor in combination. The template allows the system to control haptic feedback based upon the interplay of the external factors.

In another example, the system may receive external factors determined from the location of the haptic feedback device, biometric data for the user, and social networking data for the user. The system may, per the template for an object, vary one or more or all of the haptic feedback properties including, but not limited to, tactile texture of the surface of an object, weight of the object, momentum of an object, rigidity of the object, elasticity of the object, and the like. For example, texture of an object may be varied a first amount (made rougher or smoother) according to location, varied a second amount (made rougher or smoother) according to a biometric data item such as skin sensitivity or the like, and varied a third amount (made rougher or smoother) according to social networking data such as emotional state, mood, or sentiment. Thus, texture may be varied in accordance with a combination of each of the external factors noted in varying degree in accordance with the template.

In still another example, as noted, the system may conditionally vary one or more haptic feedback properties according to one external factor or a combination of two or more external factors. For example, the system may conditionally vary texture according to location and/or biometric data. Once the system determines that the texture is to be varied according to the first external factor or set of first external factors, the system may vary the texture according to the first external factor, the set of first external factors, or vary the texture according to one or more other, different external factors not used to determine whether the texture (or one or more other haptic feedback properties) is variable. In still another aspect, the system may vary a first haptic feedback property according to one or more external factors, vary a second haptic feedback property according to one or more external factors, etc.

In block 355, the system may send the haptic feedback determined in block 350 to the haptic feedback device of the user.

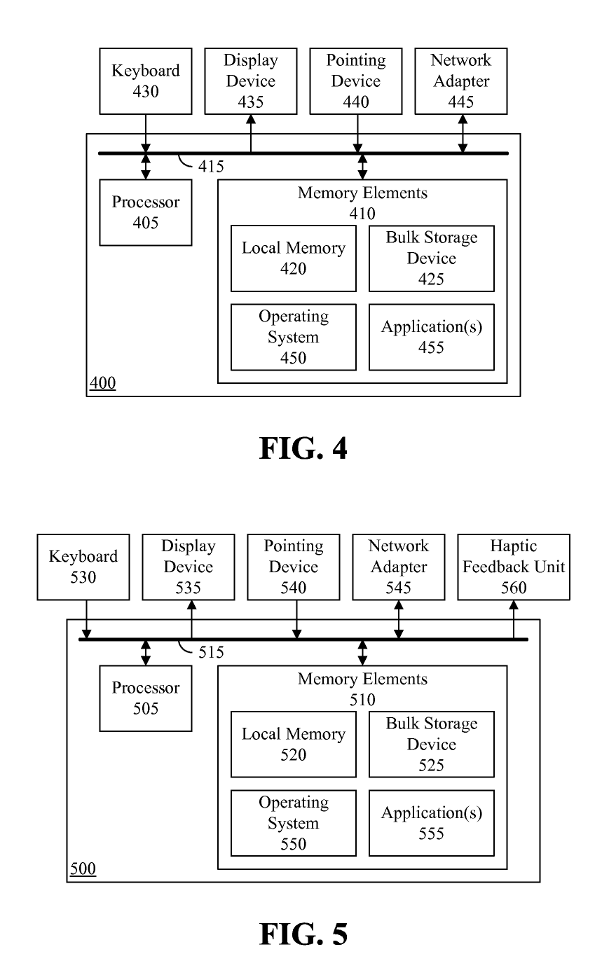

FIG. 4 is a block diagram illustrating an exemplary architecture 400 for a data processing system. Architecture 400 may be used to implement a computer that is suitable for storing and/or executing program code. It should be appreciated, however, that architecture 400 may be used to implement any system including a processor and memory that is capable of performing the operations described within this disclosure. In one aspect, for example, architecture 400 may be used to implement haptic feedback system 130 of FIGS. 1 and/or 2.

Architecture 400 includes at least one processor 405, e.g., a central processing unit (CPU), coupled to memory elements 410 through a system bus 415 or other suitable circuitry. Architecture 400 stores program code within memory elements 410. Processor 405 executes the program code accessed from memory elements 410 via system bus 415. In one aspect, architecture 400 may be used to implement a computer or other data processing system that is suitable for storing and/or executing program code. It should be appreciated, however, that architecture 400 may be used to implement any system including a processor and memory that is capable of performing the functions described within this disclosure.

Memory elements 410 include one or more physical memory devices such as, for example, a local memory 420 and one or more bulk storage devices 425. Local memory 420 may be implemented as a random access memory (RAM) or other non-persistent memory device(s) generally used during actual execution of the program code. Bulk storage device 425 may be implemented as a hard disk drive (HDD), solid state drive (SSD), or other persistent data storage device. Architecture 400 also may include one or more cache memories (not shown) that provide temporary storage of at least some program code in order to reduce the number of times program code must be retrieved from the bulk storage device during execution.

Input/output (I/O) devices such as a keyboard 430, a display device 435, and a pointing device 440 optionally may be coupled to architecture 400. The I/O devices may be coupled to architecture 400 either directly or through intervening I/O controllers. A network adapter 445 may also be coupled to architecture 400 to enable a system implemented using architecture 400 to become coupled to other systems, computer systems, remote printers, remote and/or storage devices through intervening private or public networks. Modems, cable modems, Ethernet cards, and wireless transceivers are examples of different types of network adapter 445 that may be used with architecture 400.

Memory elements 410 store an operating system 450 and an application 455. Operating system and application 455, being implemented in the form of executable program code, are executed by architecture 400. As such, operating system 450 and/or application 455 may be considered an integrated part of any system implemented using architecture 400. Application 455, for example, may include instructions that, when executed, cause a system implemented using architecture 400 to perform the various operations described with reference to haptic feedback system 130 and/or FIG. 3. Application 455 and any data items used, generated, and/or operated upon by architecture 400 while executing application 455 are functional data structures that impart functionality when employed as part of architecture 400.

While architecture 400 may be used to implement haptic feedback system 130, it should be appreciated that architecture the same as or similar to that of FIG. 4 may also be used to implement one or more or any combination of collector 105, analytics engine 110, insights aggregator 115, contextual manager 120, and/or Website 125.

FIG. 5 is a block diagram illustrating an exemplary architecture 500 for a haptic feedback device. Architecture 500 may be used to implement a haptic feedback device such as haptic feedback device 165 of FIG. 1. Architecture 500 may be implemented to include at least one processor 505 coupled to memory elements 510 through a system bus 515 or other suitable circuitry. Architecture 500 stores program code within memory elements 510. Processor 505 executes the program code accessed from memory elements 510 via system bus 515.

Memory elements 510 include one or more physical memory devices such as, for example, a local memory 520 and one or more bulk storage devices 525. Input/output (I/O) devices such as a keyboard 530, a display device 535, and a pointing device 540 optionally may be coupled to architecture 500. The I/O devices may be coupled to architecture 500 either directly or through intervening I/O controllers. A network adapter 545 may also be coupled to architecture 500 to enable a system implemented using architecture 500 to become coupled to other systems, computer systems, remote printers, remote and/or storage devices through intervening private or public networks. Modems, cable modems, Ethernet cards, and wireless transceivers are examples of different types of network adapter 545 that may be used with architecture 500.

Architecture 500 further may include a haptic feedback unit 560. Haptic feedback unit 560 may be coupled to architecture 500 either directly or through an intervening I/O controller. Haptic feedback unit 560 may be configured to generate any of a variety of forces and/or vibrations. Haptic feedback unit 560, for example, may include one or more haptic feedback sensors such as motors, and the like. The particular haptic feedback sensors and/or devices described herein are not intended to be limiting. The haptic feedback sensors may render haptic feedback received by architecture 500 under control of processor 505 to emulate the touch and/or feel of an object to a user.

It should be appreciated that while haptic feedback unit 560 is illustrated as being independent of other I/O devices, in another aspect, haptic feedback unit 560 may be incorporated into one or more other I/O devices. For example, haptic feedback unit 560 may be incorporated into display device 535 as a haptic feedback enabled display or tactile electronic display, into a pointing device 540, into a keyboard 530, or the like. Further, it should be appreciated that while architecture 500 may be used in a laptop computing device, a mobile communication device, or other computing device, architecture 500 may also be incorporated into a dedicated haptic feedback device such as a wearable haptic feedback device. In that case, architecture 500 may include fewer or more components than shown.

Memory elements 510 may store an operating system 550 and an application 555. In another aspect, operating system 550 and application 555 may be combined into an integrated or single computer program as may be the case for an embedded device. Operating system and application 555, being implemented in the form of executable program code, are executed by architecture 500. As such, operating system 550 and/or application 555 may be considered an integrated part of any system implemented using architecture 500. Application 555 and any data items used, generated, and/or operated upon by architecture 500 while executing application 555 are functional data structures that impart functionality when employed as part of architecture 500.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the term “another” means at least a second or more.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “coupled” means connected, whether directly without any intervening elements or indirectly with one or more intervening elements, unless otherwise indicated. Two elements may be coupled mechanically, electrically, or communicatively linked through a communication channel, pathway, network, or system.

As defined herein, the term “executable operation” or “operation” is a task performed by a data processing system or a processor within a data processing system unless the context indicates otherwise. Examples of executable operations include, but are not limited to, “processing,” “computing,” “calculating,” “determining,” “displaying,” “comparing,” or the like. In this regard, operations refer to actions and/or processes of the data processing system, e.g., a computer system, or similar electronic computing device, that manipulates and transforms data represented as physical (electronic) quantities within the computer system's registers and/or memories into other data similarly represented as physical quantities within the computer system memories and/or registers or other such information storage, transmission or display devices.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “plurality” means two or more than two.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “program code,” “software,” “application,” and “executable code” mean any expression, in any language, code or notation, of a set of instructions intended to cause a data processing system to perform a particular function either directly or after either or both of the following: a) conversion to another language, code, or notation; b) reproduction in a different material form. Examples of program code may include, but are not limited to, a subroutine, a function, a procedure, an object method, an object implementation, an executable application, an applet, a servlet, source code, object code, a shared library/dynamic load library and/or other sequence of instructions designed for execution on a computer system.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1.A method, comprising:
responsive to determining that a user is proximate to a haptic feedback device, determining, using a processor, a location of the haptic feedback device;
receiving, using the processor, a plurality of external factors determined from the location of the haptic feedback device, biometric data for the user, and social networking data for the user; and
determining, using the processor, a haptic feedback for use by the haptic feedback device by applying the external factors to a haptic feedback template of an object.

2. The method of claim 1, further comprising:
sending the haptic feedback to the haptic feedback device of the user.

3. The method of claim 1, further comprising:
determining whether a haptic feedback property defined in the haptic feedback template for the object is variable responsive to the external factors; and
adjusting the haptic feedback property according to the external factors responsive to determining that the haptic feedback property is variable.

4. The method of claim 1, further comprising:
determining, according to a first external factor of the plurality of external factors, whether a haptic feedback property defined by the haptic feedback template of the object is variable; and
adjusting the haptic feedback property according to a second external factor of the plurality of external factors responsive to determining that the haptic feedback property is variable.

5. The method of claim 1, wherein an external factor of the plurality of external factors is an emotional state of the user determined from the social networking data.

6. The method of claim 1, wherein an external factor of the plurality of external factors determined from the biometric data comprises skin sensitivity of the user.

7. The method of claim 1, further comprising:
determining the external factors from a user profile of the user and a real time feed from a social networking site.

8. A system, comprising:
a processor programmed to initiate executable operations comprising:
responsive to determining that a user is proximate to a haptic feedback device, determining a location of the haptic feedback device;
receiving a plurality of external factors determined from the location of the haptic feedback device, biometric data for the user, and social networking data for the user; and
determining, using the processor, a haptic feedback for use by the haptic feedback device by applying the external factors to a haptic feedback template of an object.

9. The system of claim 8, wherein the processor is further programmed to initiate executable operations comprising:
sending the haptic feedback to the haptic feedback device of the user.

10. The system of claim 8, wherein the processor is further programmed to initiate executable operations comprising:
determining whether a haptic feedback property defined in the haptic feedback template for the object is variable responsive to the external factors; and
adjusting the haptic feedback property according to the external factors responsive to determining that the haptic feedback property is variable.

11. The system of claim 8, wherein the processor is further programmed to initiate executable operations comprising:
determining, according to a first external factor of the plurality of external factors, whether a haptic feedback property defined by the haptic feedback template of the object is variable; and
adjusting the haptic feedback property according to a second external factor of the plurality of external factors responsive to determining that the haptic feedback property is variable.

12. The system of claim 8, wherein an external factor of the plurality of external factors is an emotional state of the user determined from the social networking data.

13. The system of claim 8, wherein an external factor of the plurality of external factors determined from the biometric data comprises skin sensitivity of the user.

14. The system of claim 8, wherein the processor is further programmed to initiate executable operations comprising:
determining the external factors from a user profile of the user and a real time feed from a social networking site.

15. A computer program product comprising a computer readable storage medium having program code stored thereon, the program code executable by a processor to perform a method comprising:
responsive to determining that a user is proximate to a haptic feedback device, determining, using a processor, a location of the haptic feedback device;
receiving, using the processor, a plurality of external factors determined from the location of the haptic feedback device, biometric data for the user, and social networking data for the user; and
determining, using the processor, a haptic feedback for use by the haptic feedback device by applying the external factors to a haptic feedback template of an object.

16. The computer program product of claim 15, further comprising:
determining whether a haptic feedback property defined in the haptic feedback template for the object is variable responsive to the external factors; and
adjusting the haptic feedback property according to the external factors responsive to determining that the haptic feedback property is variable.

17. The computer program product of claim 15, further comprising:
determining, according to a first external factor of the plurality of external factors, whether a haptic feedback property defined by the haptic feedback template of the object is variable; and
adjusting the haptic feedback property according to a second external factor of the plurality of external factors responsive to determining that the haptic feedback property is variable.

18. The computer program product of claim 15, wherein an external factor of the plurality of external factors is emotional state of the user determined from the social networking data.

19. The computer program product of claim 15, wherein an external factor of the plurality of external factors determined from the biometric data comprises skin sensitivity of the user.

20. The computer program product of claim 15, further comprising:
determining the external factors from a user profile of the user and a real time feed from a social networking site.
